(19) United States
(12) Patent Application Publication
(10) Pub. No.: US 2003/0134007 A1
(43) Pub. Date: Jul. 17, 2003

(54) Product and process of making an alcohol containing sport drink

(76) Inventor: Erik Thurman Donhowe, Castle Rock, CO (US)

Correspondence Address: Erik T. Donhowe, Suite 243, 200 South Wilcox Street, Castle Rock, CO, 80104, US

(21) Appl. No.: 10/047,411

(22) Filed: Jan. 16, 2002

(51) Int. Cl. A23L 1/30

(52) U.S. Cl. 426/72

(57) ABSTRACT

A process is provided for the preparation of an alcohol containing sport drink that has enhanced nutrition in comparison to existing alcoholic drinks. The beverage comprises a clear, colorless or colored, beverage containing protein, peptide, amino acid and vitamin supplements, with low to moderate levels of ethyl alcohol. Such a beverage provides a healthier alternative to conventional malt beverages, beer, wine or distilled alcoholic beverages, especially when consumed in post recreational sport social contexts.

### CROSS-REFERENCE TO RELATED APPLICATIONS

Not Applicable

### FEDERALLY SPONSORED RESEARCH OR DEVELOPMENT

Not Applicable

### MICROFICHE APPENDIX

Not Applicable

### BACKGROUND OF THE INVENTION

This invention relates to new sport drinks and to a method of producing the same. Intensive energy-consuming sport activities such as golf, skiing, tennis, fitness workouts, baseball, football and general athletics are increasingly becoming popular as adult recreational activities. The context in which these activities occur commonly includes post-recreational social gatherings, during which alcoholic beverages are often consumed. Hitherto, alcoholic beverages consumed at these events have been limited in nutritional needs associated with recreational activities; alcoholic beverages such as beer, wine and mixed drinks are typically low in contents of protein, minerals, antioxidants and vitamins. Beer typically contains 13 g of carbohydrates, 1 g of protein, and no vitamin A or C per 12 fluid ounce servings. Wine typically contains 2 g of carbohydrates, no protein, and no vitamin A or C per 12 fluid ounce servings. Distilled alcoholic beverages such as vodka or martinis typically contain no carbohydrate, no protein, and no vitamin A or C per 12 fluid ounce servings.

Protein supplementation aids anabolic metabolism, as protein is a key nutritional component required for building muscles. Intensive recreational activities stimulate the need to rebuild and strengthen muscle fibers; hence protein supplementation is helpful to supply protein and amino acid needs following the recreational activities.

Vitamin supplementation to beverages aids energy metabolism, as vitamins are primary cofactors used in electron transfer steps in anabolic and catabolic metabolism. Vitamins such as vitamin C and vitamin E also function as antioxidants.

In outdoor recreational activities, ultraviolet light exposure can result in the production of free radicals in the body. Additionally, high aerobic respiration during these activities results in high oxygen levels and resultant free radical formation. Free radical formation leads to radical chain reactions and catabolism of protein and other tissues in the body, and it also contributes to physical exhaustion and potentially even carcinogenesis. Antioxidants serve to react with free radicals, terminating such deleterious radical chain reactions.

The present invention describes a clear/translucent alcoholic beverage that contains protein supplementation, vitamin supplementation, mineral supplementation, antioxidants, flavoring, sweeteners and buffering agents. Other inventions describe vitamin, protein and mineral supplementation in beverages; however, none of these inventions relate to an alcoholic beverage intended for post-recreational consumption.

U.S. Pat. No. 5,851,578 issued to Soma Technologies describes a clear or translucent beverage that contains dietary fiber, vitamins and calcium intended for consumption by individuals with dietary deficiencies in these nutrients.

U.S. Pat. No. 4,992,282 issued to the Proctor & Gamble Company describes a vitamin and mineral fortified beverage that contains vitamin A, vitamin C, riboflavin, iron and calcium intended for consumption by individuals with dietary deficiencies in these nutrients.

U.S. Patent Application. No. 20010008641 issued to Krotzer describes a nutritionally active composition for bodybuilding. This invention describes the formulation of whey peptides, creatine monohydrate, potassium, phosphorous, and amino acids in a beverage vehicle to deliver nutrients to a recipient. The formulation described is alcohol free and is designed for bodybuilding applications.

U.S. Pat. No. 6,037,375 issued to Otsuka Pharmaceuticals describes a nonalcoholic beverage formulation that contains amino acids and carotenoid antioxidants. The invention is targeted to prevent fatigue during exercise.

None of the prior art described an alcoholic beverage with vitamin, antioxidant, minerals and/or protein or amino acid supplementation. This present invention satisfies the need for a post-recreational alcoholic beverage that provides these needed nutrients.

### BRIEF SUMMARY OF THE INVENTION

This invention describes a new, improved sport drink and a process for the preparation of the same. The sport drink of the invention has the flavor, color and appearance of beverages consumed during post recreational social settings, but contains substantially improved nutritional value. Typical beverages such as beer, wine and mixed drinks consumed during these settings are carbohydrate rich with low contents of protein, minerals, antioxidants and vitamins. The sport drink of this invention has nutritionally beneficial supplements to provide higher levels of protein and peptides, minerals, antioxidants and vitamins.

The process described in this invention comprises mixing the flavor components, sweeteners, buffering agents, protein or peptide supplements, vitamins, minerals and antioxidants in an aqueous solution, followed by heating or adding preservatives, cooling, adding ethyl alcohol, and packaging the product.

In an alternative embodiment of the invention, a fermentation process produces ethyl alcohol. A yeast fermentation process is conducted wherein barley malt grain is mashed, boiled in a brew kettle, the extract or wort is cooled and aerated, yeast is added, yeast fermentation occurs, yeast is removed by filtration and centrifugation, and protein supplements, vitamin supplements, calcium, zinc and/or iron, natural antioxidants, fruit flavoring, sweeteners and buffering agents are added to obtain a clear/translucent beverage.

### DETAILED DESCRIPTION OF THE INVENTION

The beverage described in this invention is clear or translucent, and is composed of 60% to 99.5% water by volume, 0.45% to 40% ethyl alcohol by volume, 3.3 to 50 grams/liter protein/branched chain amino acids, 3.3 to 50 grams/liter protein, 0.1 to 50 grams/liter buffers, 3.3 to 50 grams/liter minerals (iron, calcium and zinc), 0.01 mg/liter to 1 grams/liter antioxidants (Vitamin C, Vitamin E and selenium, 10% to 100% of the U.S. Recommended Daily Value of vitamins (Vitamin A, Vitamin E, Vitamin C, Vitamin B1, Vitamin B2, Vitamin B6, and Vitamin B12), and flavor extract. In alternative embodiments of the invention, the sport beverage may be carbonated; it may contain caffeine, sweeteners, preservatives (sodium benzoate) and food coloring.

The process for the production of the alcohol containing sport beverage described in this invention consists of mixing into filtered water the protein supplements, vitamin supplements, calcium, zinc and/or iron, natural antioxidants, fruit flavoring, sweeteners and buffering agents, and ethyl alcohol. Prior to the addition of the ethyl alcohol, the mixture may be heated to 85 to 90 degrees C. for 1 to 3 minutes, followed by cooling to 20 to 30 degrees C. Alternatively, the heating step may be omitted when artificial sweeteners are used in place of fructose, corn syrup, sucrose, honey, or glucose sweeteners.

In one embodiment of the invention, the ethyl alcohol component is provided by directly adding ethyl alcohol into the mixture after all ingredients have been added and the mixture has been heated, cooled and filtered; immediately prior to packaging.

In an alternative embodiment of the invention, a fermentation process occurs first in the process. Barley malt grain is mashed, boiled in a brew kettle with or without hops, and the extract (wort) is cooled, clarified and aerated. Brewing yeast is added, yeast fermentation occurs, producing alcohol and flavors, and yeast is removed by filtration and clarification after the fermentation process has concluded. The protein supplements, vitamin supplements, calcium, zinc and/or iron, natural antioxidants, fruit flavoring, sweeteners and buffering agents are added after the filtration and clarification steps, prior to packaging the product. This invention is further demonstrated by the following illustrative examples.

### EXAMPLE 1

composition:

12.2 liters of filtered water

40 grams of citric acid

300 grams of high fructose corn syrup

10 g of orange flavoring

D&C Red 40, 40 mg D&C Yellow 6, 50 mg

Sodium benzoate, 15 g

Hydrolyzed proteins and branched chain amino acids, 13.3 g

Vitamin mixture, liquid concentrate, add to achieve 25% RDA in 0.355 liters concentration

Ethyl alcohol, 40%, 2.8 liters

Add the ingredients, excluding the ethyl alcohol, to water. While mixing, raise the temperature to 90 degrees C., hold at 90 degrees C. for 3 minutes, cool to 26 degrees C., add the ethyl alcohol, and immediately fill into bottles and package. The beverage has a 7.5% by volume alcohol content, providing a protein content of 2.5 gram per 12 fluid ounces, and vitamins at 25% of the RDA values.

### EXAMPLE II

composition:

9.9 liters of filtered water

apple juice concentrate, 600 ml

40 grams of citric acid

D&C Red 40, 10 mg

D&C Yellow 6, 60 mg

Hydrolyzed proteins and branched chain amino acids, 5.3 g

Vitamin mixture, liquid concentrate, add to achieve 25% RDA in 0.355 liters concentration

Ethyl alcohol, 40%, 4.5 liters

Add the ingredients, excluding the ethyl alcohol, to water. While mixing, raise the temperature to 90 degrees C., hold at 90 degrees C. for 3 minutes, cool to 26 degrees C., add the ethyl alcohol, and immediately fill into bottles and package. The beverage has a 12% by volume alcohol content, providing a protein content of 1 gram per 12 fluid ounces, and vitamins at 25% of the RDA values.

### EXAMPLE III

composition:

0.5 liters of filtered water

1 g of peppermint flavoring

FD&C red 3, 40 mg

Hydrolyzed proteins and branched chain amino acids, 5.3 g

Vitamin mixture, liquid, 100% RDA/15 liters

Ethyl alcohol, 40%, 14.5 liters

Add the ingredients, ethyl alcohol last, to water. Filter the mixture and package. The beverage has a 39% by volume alcohol content, providing a protein content of 1 gram per 12 fluid ounces, and vitamins at 100% of the RDA values.

### EXAMPLE IV

composition:

13.1 liters of filtered water

10 grams of citric acid

100 mg aspartame

10 g of peppermint flavoring

FD&C red 3, 40 mg

Sodium benzoate, 12 g

Whey peptides, 5.3 g

Vitamin mixture, liquid, 25% RDA/15 liters

Ethyl alcohol, 40%, 1.9 liters

CO2 gas, 8 liters

Add the ingredients, excluding the ethyl alcohol and CO2 gas, to water. Mix for 30 minutes. Filter, add the ethyl alcohol and carbonate with the CO2 gas. The beverage has a 5% by volume alcohol content, providing a protein content of 1 gram per 12 fluid ounces, and vitamins at 25% of the RDA values.

### EXAMPLE V

composition:

75 liters of pale malt brewed beer

75 liter filtered water

400 grams of citric acid

Whey peptides, 53 g

Vitamin mixture, liquid, 25% RDA/15 liters

Ascorbic acid, 15 grams

Citric acid, 400 grams

Tartaric acid 150 grams

Potassium phosphate, 20 grams

CO2 gas

Utilizing a conventional brewing process, mash a very pale malt grain, boil the clarified malt extracted in a brew kettle, cool the extract (wort), clarified and aerate the worth, and conduct fermentation and aging to obtain a pale beer. Add the whey protein, vitamin concentrate, ascorbic acid antioxidant, and buffering agents to the filtered water. Blend the water mixture to the aged beer, store the beverage with CO2 headspace to increase carbonation. Sterile filter the beverage and package the product into bottles, cans or kegs. The beverage has a 3 to 5% by volume alcohol content, providing a protein content of 1 gram per 12 fluid ounces, antioxidants, and vitamins at 25% of the RDA values.

Carbonation in the processes can be conducted with any conventional carbonation method, such as storage with CO2 headspace or impinging with CO2 gas. Carbonation generally consists from 1.0 to 4.5 volumes of gas.

I claim:

1. A clear/translucent, carbonated or noncarbonated, alcohol containing beverage containing protein supplementation, vitamin supplementation, mineral supplementation, antioxidants, flavoring, sweeteners and buffering agents.

2. A beverage according to claim 1, wherein the beverage contains between 0.45% and 40% alcohol by volume.

3. A beverage according to claim 1, wherein the beverage is fortified with highly nutritious and highly bioavailable supplemental protein added in final concentrations in the beverage from 0.33% to 5% by weight.

4. A beverage according to claim 3, wherein the supplemental protein consists of whey, casein, soy protein, rice protein, albumin, hydrolyzed protein, and/or highly branched chain amino acids (BCAAs).

5. A beverage according to claim 1, wherein the beverage is fortified with Vitamin A, Vitamin E, Vitamin C, Vitamin B1, Vitamin B2, Vitamin B6, and Vitamin B12 in the beverage at levels from 10% to 100% of the U.S. Recommended Daily Value.

6. A beverage according to claim 1 that contains supplemental addition of iron, calcium and zinc in concentrations of 0.01 to 0.5% by weight.

7. A beverage according to claim 1, wherein natural antioxidants such as vitamin C, vitamin E, and selenium are added.

8. A beverage according to claim 1, wherein said beverage is flavored with flavor extracts such as lemon, orange, grapefruit, lime, peach, guava, apple, cranberry, blueberry, grape, pineapple, cherry, strawberry, mango, papaya, peppermint, cinnamon, carrot, tomato, liquorice, coffee and coca.

9. A beverage according to claim 1 that contains the addition of fructose, corn syrup, sucrose, honey, glucose, sucralose, aspartame or stevia as sweeteners.

10. A beverage according to claim 1 that contains buffering agents such as citric acid, tartaric acid, malic acid, succinic acid, ascorbic acid, phosphoric acid, potassium phosphate and/or sodium phosphate in concentrations of 0.01 to 0.5% by weight.

11. A beverage according to claim 1 that contains supplemental addition of caffeine in concentrations of 0.01 to 0.5% by weight.

12. A beverage according to claim 1, wherein said beverage is clear and colored with food grade dyes such as FD&C yellow 5, FD&C red 40, FD&C blue 1, and FD&C red 3.

13. A beverage according to claim 1 that is carbonated with CO2 gas.

14. A process for the production of an alcohol containing sport beverage consisting of mixing into water protein supplements, vitamin supplements, calcium, zinc and/or iron, natural antioxidants, fruit flavoring, sweeteners and buffering agents, followed by blending ethyl alcohol into the mixture to obtain a clear/translucent beverage.

15. A process for the production of an alcohol containing sport beverage wherein alcohol is produced by yeast fermentation, as part of a brewing process wherein barley malt grain is mashed, boiled in a brew kettle, the extract or wort is cooled and aerated, and yeast is added, yeast fermentation occurs, yeast is removed by filtration and centrifugation, and protein supplements, vitamin supplements, calcium, zinc and/or iron, natural antioxidants, fruit flavoring, sweeteners and buffering agents are added to obtain a clear/translucent beverage.
